(19) United States
(12) Patent Application Publication
(10) Pub. No.: US 2026/0003534 A1
(43) Pub. Date: Jan. 1, 2026

(54) STORAGE DEVICE WITH SELF-DESTRUCTION FUNCTION

(71) Applicant: TEAM GROUP INC., New Taipei City (TW)

(72) Inventors: CHIN-FENG CHANG, New Taipei City (TW); Hsun-Chia Ma, New Taipei City (TW); Wen-Wang Wu, New Taipei City (TW); Jeng-Feng Weng, New Taipei City (TW); Kuan-Chen Chen, New Taipei City (TW); Po-Chuan Lin, New Taipei City (TW)

(21) Appl. No.: 19/316,781

(22) Filed: Sep. 2, 2025

Related U.S. Application Data
(63) Continuation-in-part of application No. 18/806,746, filed on Aug. 16, 2024.

(30) Foreign Application Priority Data
Jun. 27, 2024 (TW) 113124117
May 16, 2025 (TW) 114205014

(51) Int. Cl. G06F 3/06; G06F 21/78

(52) U.S. Cl. CPC G06F 3/0652; G06F 3/0623; G06F 3/0679; G06F 21/78; G06F 2221/2143

(57) ABSTRACT

The present application provides a storage device with self-destruction function, which comprises an upper housing, a slide button module, a storage module and a lower housing, an opening is disposed on the upper housing, the slide button module comprises a partition member disposed under the upper housing, the partition member includes a flexible part, a slide button is disposed above the partition member, and the slide button protrudes and is disposed in the opening, the storage module comprises a circuit board, a storage element, a control element and a switch, the lower housing is disposed under the storage module, the upper housing and the lower housing cover the storage module, the slide button slides toward the flexible part to press down the flexible part and force the flexible part press the switch, thereby, the control element breaks down the storage element by a boost transform circuit.

### CROSS REFERENCE TO RELATED APPLICATIONS

The present application is a continuation-in-part of U.S. patent application Ser. No. 18/806,746 (filed Aug. 16, 2024), which is incorporated by reference.

### FIELD OF THE INVENTION

The present application relates to a storage device with self-destruction function, which is a storage device for physically destructing the data of the storage element.

### BACKGROUND OF THE INVENTION

With the rapid development of information technology, data storage and transmission have become more and more convenient, and solid state drives (SSDs) have been widely used in personal computers, mobile devices, servers and cloud storage systems.

The SSD is originally designed to replace the traditional hard disk drive, and the main element for storing data is an integrated circuit used as a storage element. Compared with the traditional hard disk drive using a motor rotating an internal disk to read and write data by rotating the disk and using related access control circuit, the storage element for accessing data in the SSD is an integrated circuit, so there is no magnetic disk and internal mechanical parts, and the data access mechanism of the SSD is completely different from that of the traditional hard disk drive.

In various confidential management fields, information security is particularly important. Data leakage may lead to significant economic losses or security risks. In order to prevent unauthorized access, the common methods in the prior art include data encryption, access permission control, remote deletion and the like.

However, only relying on data encryption, formatting or simple data replacing, the restoration behavior of high-level data recovery tools cannot be completely prevented in the SSD as described above. Therefore, how to ensure the reliability of data destruction while considering fast execution is an important problem that has not been perfectly solved in the prior art.

In summary, the prior art provides a certain degree of data protection and self-destruction capability, but there are still problems such as incomplete data deletion, insufficient triggering reliability, limited device use flexibility and the like, and there is still room for improvement. Therefore, in order to ensure user information security and privacy, it is necessary to destruct the data of the SSDs in a physical form conveniently and quickly.

In view of the above problems of the prior art, the present application provides a storage device with a self-destruction function, which is triggered by a slide button to physically destruct the data of a storage element by a control element.

### SUMMARY OF THE INVENTION

An objective of the present application is to provide a storage device with a self-destruction function, which is triggered by a slide button to physically destruct the data of a storage element by a control element in a voltage breakdown manner, so as to quickly and ensure that the data of the storage device is deleted.

To achieve the aforementioned objective, the present application provides a storage device with a self-destruction function, which comprises an upper housing, a slide button module, a storage module and a lower housing, wherein an opening is penetrated through the upper housing; the slide button module comprises a partition member disposed under the upper housing, and the partition member includes a flexible part; a slide button member slides on the partition member, and protrudes from and slides on the opening; the storage module comprises a circuit board disposed under the partition member; a storage element is electrically connected to and disposed on the circuit board; a control element is electrically connected to and disposed on the circuit board, the control element is electrically connected to the storage element, the control element comprises a voltage conversion unit, the voltage conversion unit is electrically connected to the storage element; a switch is disposed on the upper surface of the circuit board corresponding to the flexible part, and the switch is electrically connected to the control element; the lower housing is disposed under the storage module, and the upper housing and the lower housing cover the storage module; wherein the slide button member slides between the opening and the partition member, the slide button member slides and presses the flexible part, the flexible part presses the switch and generates a pressing signal, the control element generates a voltage signal to the storage element according to the pressing signal to break down the storage element; the device is triggered by the switch to self-destruct, and the data of the storage device is quickly and reliably deleted.

In an embodiment of the present application, wherein a limiting member is disposed on an inner side of the upper housing and disposed under the slide button.

In an embodiment of the present application, wherein a buckle member is disposed on the outer side of the slide button. When the slide button slides toward the flexible part to press the flexible part, the buckle member moves from one side of the limiting member to the another side of the limiting member, so that the buckle member is gotten stuck on the other side of the limiting member.

In an embodiment of the present application, wherein a protruding member is disposed under the flexible part. When the slide button slides toward flexible part to press the flexible part, the protruding member presses the switch.

In an embodiment of the present application, wherein a slide rail is disposed on the upper side of the partition member, and the slide button slides on the partition member.

In an embodiment of the present application, wherein the circuit board includes a connection port, which is electrically connected to the circuit board and is electrically connected to the control element.

In an embodiment of the present application, wherein a connection port is disposed on the outer side of the lower housing, and the connection port is disposed through the connection port.

In an embodiment of the present application, wherein the connection port of the circuit board is a universal serial bus.

In an embodiment of the present application, wherein a power module is disposed between the upper housing and the partition member, and the power module is electrically connected to the control element and the boost transformation circuit.

### BRIEF DESCRIPTION OF DRAWINGS

FIG. 1 is an exploded view according to an embodiment of the present application;

FIGS. 2A-2B are schematic views of the operation of a slide button of an embodiment of the present application;

FIG. 3 is a schematic view of the electrical connection according to an embodiment of the present application;

FIG. 4 is an exploded view of the top structure according to an embodiment of the present application;

FIGS. 5A-5C are schematic views of the operation of a slide button according to an embodiment of the present application; and

FIG. 6 is an exploded view of other elements according to an embodiment of the present application.

### DETAILED DESCRIPTION OF THE INVENTION

In view of the problems of the prior art, the present application is a slide button module and a storage module covered by an upper housing and a lower housing. A partition member of the slide button module includes a flexible part. A slide button slides on the upper side of the partition member toward the flexible part to press the flexible part, so that the flexible part presses a switch included in the storage module. A control element uses a boost transformation circuit to break a storage element of the storage module, so as to delete the data of the storage element, thereby solving the problems of incomplete data deletion and insufficient triggering reliability of the storage device in the prior art.

In the following detailed description, embodiments of the present application will be described by way of illustration only. The concepts of the present application, however, may be embodied in a wide variety of forms, and should not be construed as being limited to the examples set forth herein.

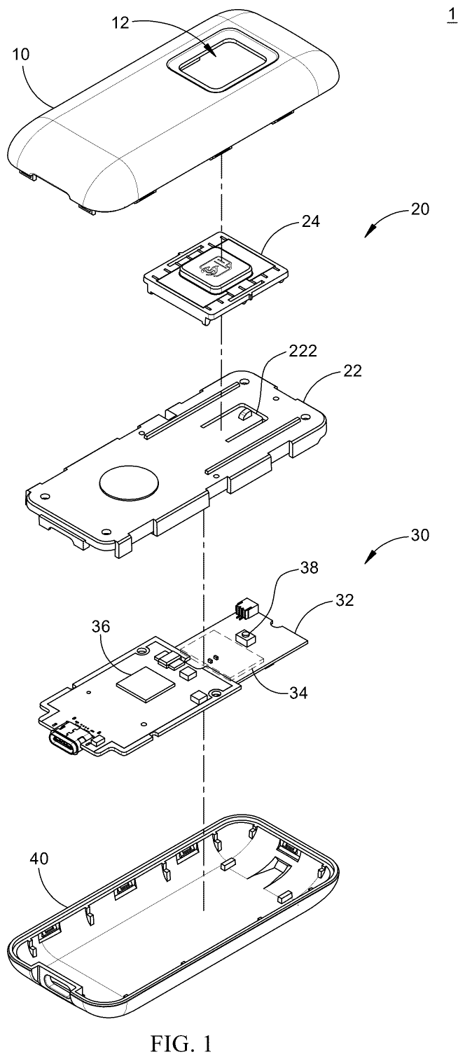

Referring to FIG. 1, which is an exploded schematic view of an embodiment of the present application. As shown in FIG. 1, the embodiment is a first embodiment. The embodiment is a storage device 1 with a self-destruction function, in which the storage device 1 comprises an upper housing 10, a slide button module 20, a storage module 30 and a lower housing 40.

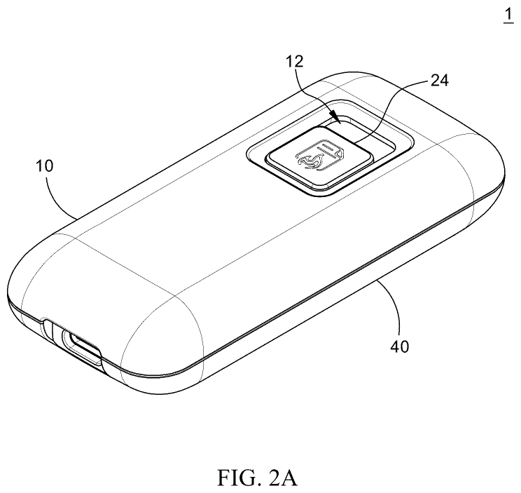

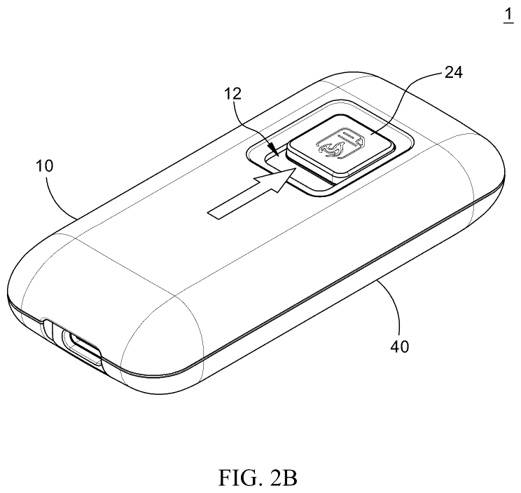

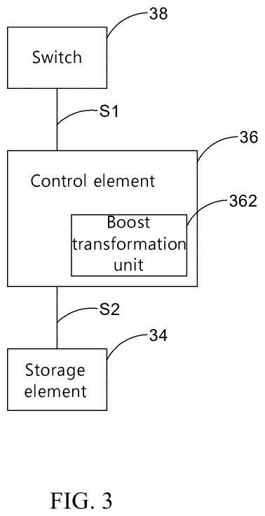

Referring again to FIG. 1 and FIG. 2A to FIG. 2B and FIG. 3, FIG. 2A to FIG. 2B are schematic views of slide button operation of an embodiment of the present application, and FIG. 3 is a schematic view of electrical connection of an embodiment of the present application. As shown in FIG. 1 to FIG. 3, the embodiment is the first embodiment. In the embodiment, an opening 12 is disposed on and penetrated through an upper portion of the upper housing 10, the slide button module 20 comprises a partition member 22 and a slide button member 24, the partition member 22 is disposed on a lower portion of the upper housing 10, the partition member 22 includes a flexible portion 222, the slide button member 24 is disposed on an upper portion of the partition member 22, and the slide button member 24 protrudes and is disposed in the opening 12.

Continued with the above, the storage module 30 comprises a circuit board 32, a storage element 34, a control element 36 and a switch 38, the circuit board 32 is disposed on a lower portion of the partition member 22, the storage element 34 is electrically connected to and disposed on the circuit board 32, the control element 36 is electrically connected to and disposed on the circuit board 32, the control element 36 is electrically connected to the storage element 34, the control element 36 comprises a boost transformation circuit 362, the boost transformation circuit 362 is electrically connected to the storage element 34, the switch 38 is disposed on the upper portion of the circuit board 32 corresponding to the flexible portion 222, the switch 38 is electrically connected to the control element 36, and the switch 38 is used for triggering the boost transformation circuit 362 by the control element 36, so that the boost transformation circuit 362 burns the storage element 34.

Continued with the above, the slide button member 24 slides between the opening 12 and the partition member 22, when the slide button member 24 slides and presses on an upper portion of the flexible portion 222, the slide button member 24 presses the flexible portion 222, so that the flexible portion 222 presses the switch 38 and generates a pressing signal S1, the control element 36 generates a voltage signal S2 to the storage element 34 according to the pressing signal S1, so as to break the storage element 34 and delete the data stored in the storage element 34.

Continued with the above, in the embodiment, the flexible portion 222 is cut out from the partition member 22 by disposing a U-shaped cutting groove, so that the flexible portion 222 may be bent downward to press the switch 38.

In the embodiment, the storage element 34 and the control element 36 are electrically connected to each other via the circuit board 32. The boost transformation circuit 362 of the control element 36 is also electrically connected to the storage element 34. The switch 38 is electrically connected to the control element 36 via the circuit board 32.

In the embodiment, the storage element 34 is a non-volatile memory or a storage element including a memory, such as an M.2 solid state drive (SSD).

In the embodiment, the switch 38 generates the pressing signal S1 after the switch 38 is pressed by the flexible portion 222.

In an embodiment, the storage module 30 may further include a conversion module. The circuit board 32 is electrically connected to the conversion module. The conversion module and the circuit board 32 are used to reduce the cost of redesigning the storage module 30.

In an embodiment, the slide button member 24 protrudes from the opening 12, so that a user may push the slide button member 24.

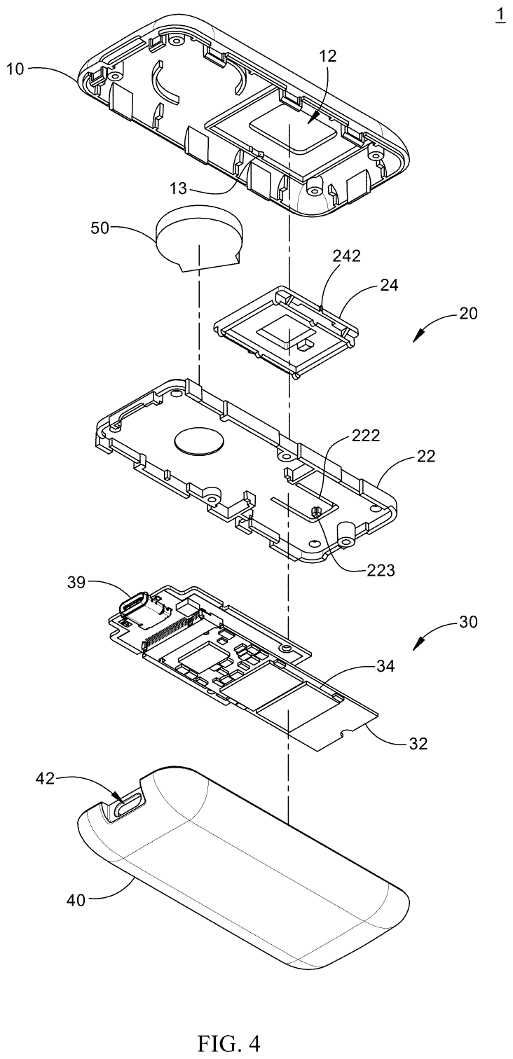

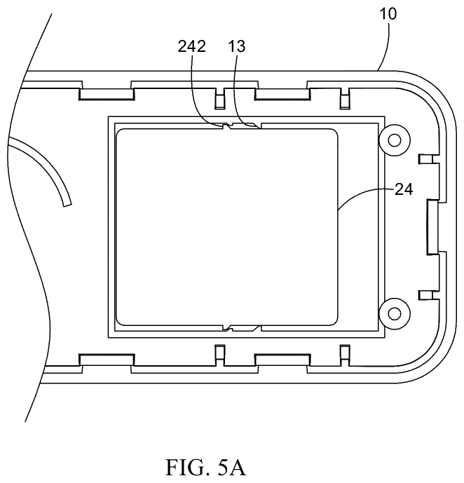

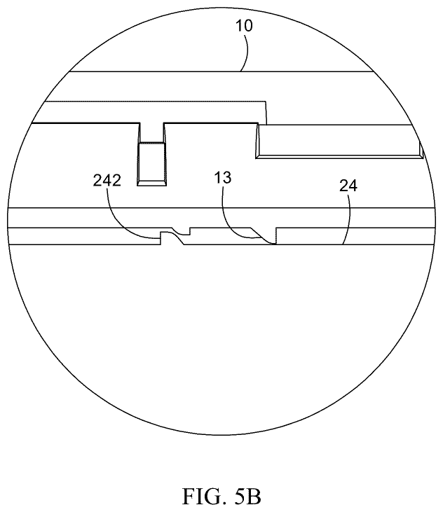

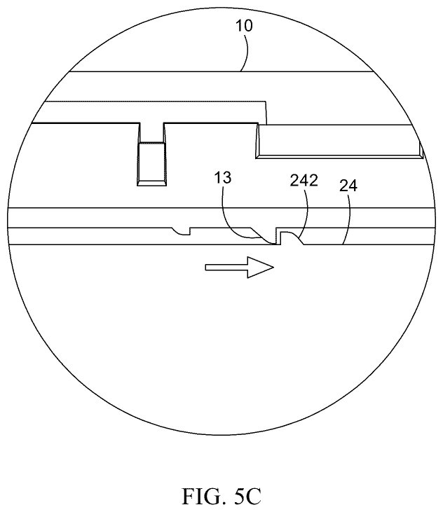

Referring to FIG. 4 and FIG. 5A to FIG. 5C, FIG. 4 is an exploded view of an embodiment of the present application, and FIG. 5A to FIG. 5C are enlarged views of the slide knob of an embodiment of the present application. As shown in the figures, the present embodiment is based on the first embodiment. In the present embodiment, a limiting member 13 is disposed on the inner side of the upper housing 10 and disposed under the slide button member 24. The limiting member 13 is disposed on the outer side of the opening 12. A buckle member 242 is disposed on the outer side of the slide button member 24. When the slide button member 24 slides toward the flexible portion 222 to press the flexible portion 222, the buckle member 242 moves from one side of the limiting member 13 to the other side of the limiting member 13, so that the buckle member 242 is disposed on the other side of the limiting member 13, and the slide button member 24 is fixed at the position after sliding. The storage element 34 of the storage module 30 is clearly shown to the user to avoid misjudgment.

In the embodiment, the limiting member 13 is flexible due to the material property. The buckle member 242 is also flexible. When the limiting member 13 and the buckle member 242 collide with each other, they may be temporarily deformed, so that the buckle member 242 may move from one side of the limiting member 13 to another side of the limiting member 13.

In the embodiment, the limiting member 13 and the buckle member 242 correspondingly include inclined surfaces, which may assist the buckle member 242 to move to the another side of the limiting member 13 (as shown in FIG. 5C).

Continued with the above, and referring again to FIG. 1, in the present embodiment, when the data does not need to be deleted, the buckle 242 of the slide button member 24 is in the position shown in FIG. 5B, and when the storage device 1 with the self-destruction function needs to be discarded, in order to avoid incomplete data deletion, the user may push the slide button member 24 to the position shown in FIG. 5C, the buckle 242 in this position is gotten stuck on the limiting member 13, and the slide button member 24 presses the flexible part 222 downward, so that the flexible part 222 presses the switch 38, and the control element 36 breaks down the storage element 34 by the boost transformation circuit 362.

In an embodiment, the slide button member 24 is an element that may press the flexible part 222 downward, and a protruding block may be further disposed under the slide button member 24 or a protruding inclined surface may be disposed above the flexible part 222, so that the slide button member 24 may surely press the flexible part 222 downward when sliding.

Referring again to FIG. 4 and FIGS. 5A to 5C, as shown, the present embodiment is based on the above first embodiment, and in the present embodiment, a protruding member 223 is further disposed under the flexible part 222, when the slide button member 24 slides toward the flexible part 222 to press the flexible part 222, the protruding member 223 of the flexible part 222 corresponds to press the switch 38 (as shown in FIG. 1), so that the control element 36 burns the storage element 34 by the boost transformation circuit 362, ensuring that the data of the storage element 34 is deleted.

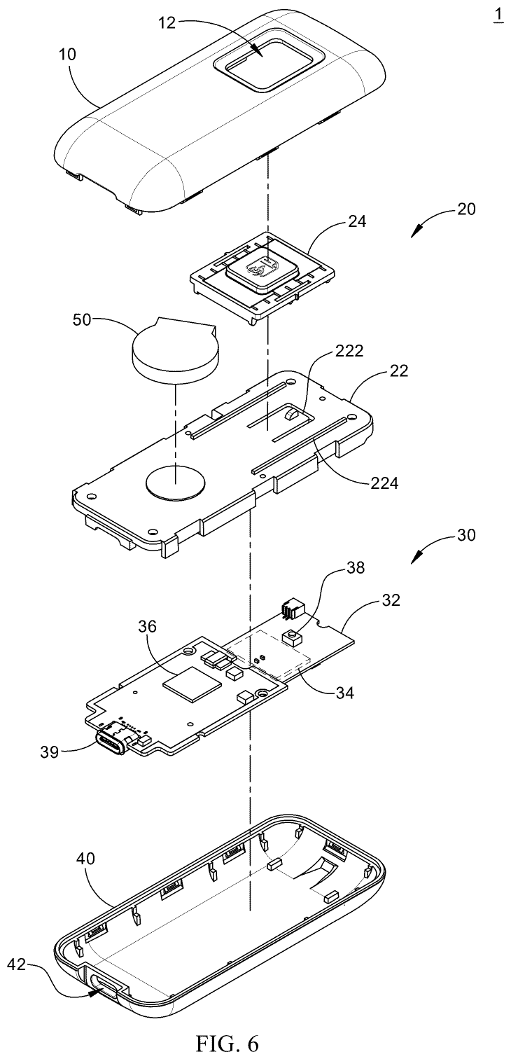

Referring to FIG. 6, which is an exploded schematic diagram of the structure of other elements of an embodiment of the present application, as shown, the present embodiment is based on the above first embodiment, and in the present embodiment, a sliding rail 224 is disposed above the partition member 22, so that the slide button member 24 is slidably disposed on the partition member 22, avoiding displacement of the slide button member 24 out of design.

Referring again to FIG. 6, as shown, the present embodiment is based on the above embodiments, and in the present embodiment, the circuit board 32 includes a connection port 39, the connection port 39 is electrically connected and disposed on the circuit board 32, the connection port 39 is electrically connected with the control element 36, and the control element 36 reads and writes the storage element 34.

Continued with the above, the lower housing 40 includes a connection opening 42 corresponding to the connection port 39, the connection port 39 is penetrated through the connection opening 42 while the connection opening 42 is penetrated through the lower housing 40, so that the connection port 39 may pass through the lower housing 40 to connect external devices.

Continued with the above, in the present embodiment, the connection port 39 may be a universal serial bus, such as a USB Type-C transmission interface, but is not limited thereto.

Referring to FIG. 6 again, the present embodiment is based on the above embodiments, and further comprises a power module 50 disposed between the upper housing 10 and the partition member 22. The power module 50 is electrically connected to the control element 36 and the boost transformation circuit 362, and provides power to the control element 36 and the boost transformation circuit 362 to burn the storage element 34.

In summary, the present application provides a storage device with a self-destruction function. A slide button disposed outside the shell is pushed by a user. When the slide button slides to the end of the stroke, the slide button presses a flexible part inside the shell. The flexible part presses a switch included in a storage module. A control element and a boost transformation circuit break the storage element of the storage module, ensuring that the data of the storage element is completely deleted. The problem of incomplete data deletion and insufficient triggering reliability of conventional storage devices is solved.

Therefore, the present application is novel and progressive, and may be used in industry. The present application meets the requirements for patent application, and patent application is filed. The present application is granted as soon as possible.

The above description is only an embodiment of the present application, and is not used to limit the scope of the present application. Any equivalent change and modification made according to the shape, structure, feature and spirit of the present application should be included in the patent application range of the present application.

1. A storage device with a self-destruction function, comprising:
an upper housing, including an opening penetrated through there;
a slide button module, comprising:
a partition member, disposed under the upper housing, the partition member including a flexible part; and
a slide button member, sliding on the partition member, and protruded and sliding on the opening;
a storage module, comprising:
a circuit board, disposed under the partition member;
a storage element, electrically connected to and disposed on the circuit board;
a control element, electrically connected to and disposed on the circuit board, the control element further electrically connected to the storage element, the control element comprising a boost transformation circuit electrically connected to the storage element; and
a switch, disposed on the circuit board corresponding to the flexible portion, the switch electrically connected to the control element; and
a lower housing, disposed under the storage module, the upper housing and the lower housing covering the storage module;
wherein the slide button member slides between the opening and the partition member, the slide button member slides toward the flexible portion to press down the flexible portion, and force the flexible portion press the switch to control the switch generating a pressing signal, the control element controls the boost transformation circuit generating a voltage signal to the storage element according to the pressing signal, so as to break down the storage element.

2. The storage device with self-destruction function of claim 1, wherein the upper housing includes a limiting member disposed at an inner side thereof and disposed corresponding to the slide button member.

3. The storage device with self-destruction function of claim 2, wherein the slide button member includes a buckle member disposed at an outer side thereof, when the slide button member slides toward the flexible portion and presses down the flexible portion to force the flexible portion press the switch to control the switch generating the pressing signal, and the buckle member moves from a side of the limiting member to another side of the limiting member, so that the buckle member is gotten stuck on the another side of the limiting member.

4. The storage device with self-destruction function of claim 1, wherein the flexible portion includes a protruding member disposed under there, when the slide button member slides toward the flexible portion and presses down the flexible portion, the protruding member presses the switch.

5. The storage device with self-destruction function of claim 1, wherein the partition member includes a sliding rail disposed thereon, the slide button member slides on the sliding rail.

6. The storage device with self-destruction function of claim 1, wherein the circuit board includes a connecting port electrically connected to and disposed on the circuit board, and the connecting port is further electrically connected to the control element.

7. The storage device with self-destruction function of claim 6, wherein the lower housing includes a connection opening penetrated through thereof, and the connecting port is correspondingly penetrated through the connection opening.

8. The storage device with self-destruction function of claim 6, wherein the connecting port is a universal serial bus port.

9. The storage device with self-destruction function of claim 1, further comprising a power module, disposed between the upper housing and the partition member, the power module electrically connected to the control element and the boost transformation circuit.
